(19) United States
(12) Patent Application Publication
(10) Pub. No.: US 2026/0356254 A1
(43) Pub. Date: Nov. 12, 2026

(54) CHILD SAFETY SEAT

(71) Applicant: NINGBO YUANYUAN AUTO ACCESSORIES CO., LTD, Cixi City (CN)

(72) Inventor: Xijiong FU, Cixi City (CN)

(21) Appl. No.: 19/322,879

(22) Filed: Sep. 9, 2025

(30) Foreign Application Priority Data
May 12, 2025 (CN) CN202520927025.X

(51) Int. Cl. B60N 2/28

(52) U.S. Cl. CPC B60N 2/2821

(57) ABSTRACT

A child safety seat comprises a chassis and a seat body that can move relative to the chassis, a connecting member is provided on the chassis, an adjustment hole is provided on the back of the seat body, and a linkage automatic covering structure is provided between the seat body and the connecting member, which is composed of a flexible decorative panel and a fixing assembly. The upper end of the flexible decorative panel is fixed to the back of the seat body, and the lower end is fixed to the connecting member. When the two move relative to each other, the fixing assembly deforms or displaces the flexible decorative panel through guidance or elastic action, automatically covering the adjustment hole. The flexible decorative panel has various forms such as foldable telescopic curtains, rolling curtains, and pull curtains.

### TECHNICAL FIELD

This utility model relates to the fields of automotive components and safety technology, and more specifically, to a child safety seat.

### BACKGROUND ART

In the automotive safety field, child safety seats play a crucial role in ensuring the safety of children while riding in vehicles. To accommodate the needs of children of different ages, existing child safety seats generally feature fore-and-aft adjustment. However, in practice, existing technologies have significant drawbacks in seat back adjustment.

For example, in the child safety seat invention patent application with application number 202510261895.2, when adjusting the pitch angle, the second connecting member fixed to the rotating disk moves relative to the seat back. To facilitate position control with the base, a second connecting hook is specifically provided at the top of the second connecting member. However, to provide clearance for the second connecting hook to move up and down, only an adjustment hole is provided in the seat back for the second connecting hook to move up and down. This adjustment hole remains exposed after adjustment, seriously affecting the product's aesthetics. For example, some child safety seats on the market have exposed adjustment holes on the back of the seat, giving the seat a rough appearance and undermining its supposedly refined feel.

Furthermore, the adjustment holes easily accumulate dust and debris, making them difficult to clean. Long-term dust accumulation can also interfere with the proper functioning of internal components, shortening the seat's lifespan. Although some child safety seats also feature decorative panels over the adjustment holes, conventional panels typically open and close manually. After adjusting the seat forward or backward, the user must manually operate the panel to cover the back holes, a cumbersome process. Parents have reported that the installation and operation of some child safety seats on the market is complex, making it easy for busy parents to forget to do so, leaving the back adjustment holes exposed for extended periods, significantly reducing the user experience.

In summary, developing a child safety seat with a linkage mechanism that links seat adjustment to the movement of the decorative panel, enabling automatic covering of the back adjustment holes, simplifying the decorative panel operation process, and improving user experience and product quality has become a key issue that needs to be addressed.

### INVENTION SUMMARY

The technical problem addressed by this utility patent is to provide a child safety seat that effectively addresses the aesthetic and cleanability issues associated with exposed seat back adjustment holes, while also simplifying the operation of decorative panels by providing a linkage structure, thereby automatically covering the back adjustment holes.

The technical solution employed by this utility model to address the aforementioned technical problems is as follows: a child safety seat comprising a chassis and a seat body that moves relative to the chassis during adjustment. The chassis is provided with a connector that moves relative to the seat body during adjustment. The back of the seat body is provided with an adjustment hole that avoids a protruding portion of the connector.

A linkage-type automatic covering structure is provided between the seat body and the connector. The linkage-type automatic covering structure comprises a flexible decorative panel and a fixing assembly. The upper end of the flexible decorative panel is fixed to the back of the seat body, and the lower end is fixed to the connector.

The fixing assembly is configured to deform or displace the flexible decorative panel through guidance or elastic action when the connector and seat body move relative to each other, thereby automatically covering the adjustment hole. To further optimize the automatic covering structure, making it more flexible, convenient, and adaptable, the flexible decorative panel is preferably a foldable retractable curtain.

The fixing assembly includes a first mounting portion and a second mounting portion. The upper end of the retractable curtain is fixed to the back of the seat body via the first mounting portion, and the lower end is fixed to the connector via the second mounting portion.

The retractable curtain automatically covers the adjustment hole by folding or unfolding during relative movement. To ensure a more secure and reliable connection between the retractable curtain, the seat body, and the connector, while facilitating installation and removal and improving product maintainability, the first mounting portion preferably includes a fastener, via which the top of the retractable curtain is fixedly connected to the back of the seat body.

The second mounting portion includes a buckle provided at the bottom of the retractable curtain. The connector is provided with a locking hole that mates with the buckle. The buckle and the locking hole engage through the locking hole to achieve a removable connection of the bottom of the retractable curtain. To ensure a secure connection between the buckle and the latch hole, prevent loosening during use, and ensure stable operation of the retractable curtain, the latch hole preferably comprises a large and small interconnected hole.

The large hole is larger than the buckle's head, while the small hole is sized to fit the buckle's neck. After being inserted through the large hole, the buckle moves laterally to the small hole and is locked into place within the small hole through elastic deformation of the buckle's neck. To provide another reliable automatic covering structure, enrich product options, and meet user needs in various usage scenarios, the flexible decorative panel is preferably a roller blind. The fixing assembly includes a roller shaft mounting portion and a free end fixing portion.

The roller shaft mounting portion includes a roller shaft bracket mounted on the back of the seat body to secure the roller shaft of the roller blind. The free end fixing portion includes a clamping structure or a magnetic attraction member mounted on the connector to secure the roller shaft of the roller blind. The roller blind is wound or unwound through relative movement between the seat body and the connector.

To ensure smoother operation of the roller blind during automatic covering, allowing for winding and unwinding without requiring additional power, thus enhancing user convenience, the roller blind's winding shaft preferably incorporates a torsion spring, one end of which is secured to the winding shaft bracket and the other to the winding shaft. When the connecting member and the seat body are in relative motion, the free end of the roller blind is stretched or released, and the torsion spring, through its elastic potential energy, drives the winding shaft to automatically wind or unwind the blind.

To provide an effective automatic covering structure, further enhance product diversity and practicality, and meet the structural preferences of different users, the flexible decorative panel is preferably a pull curtain, and the fixing assembly includes a tension spring and a transition shaft.

One end of the pull curtain is secured to the back of the seat body via a tension spring, and the other end is secured to the connecting member. The transition shaft is disposed on the back of the seat body and is slidably connected to the middle portion of the pull curtain. When the connecting member is in the downward position, the pull curtain is pulled to cover the adjustment hole. When the connecting member is in the upward position, the tension spring drives the pull curtain to retract.

To reduce frictional resistance during the curtain's movement, extend its service life, and better adapt the curtain to the covering requirements of different adjustment levels, the transition shaft is preferably rotatable about its own axis to distribute the curtain's tensile stress and reduce frictional resistance. The ends of the tension spring are secured to the back of the seat body via adjustable bolts.

These adjustable bolts are used to adjust the preload of the tension spring to suit the covering requirements of different adjustment levels. To ensure the stability and accuracy of the flexible decorative panel's movement during the automatic covering process, ensuring it consistently and accurately covers the adjustment hole, the fixing assembly preferably provides guidance via guide slots or rails located on the back of the seat body to constrain the flexible decorative panel's movement path.

To better align the automatic covering structure with the seat's adjustment function, ensuring effective covering of the adjustment holes at all adjustment levels and improving product usability, the relative movement of the connector and seat body is preferably pitch angle adjustment, and the flexible decorative panel's coverage range corresponds to the adjustment holes exposed after the pitch angle adjustment, dynamically covering the adjustment holes exposed after adjustment.

Compared to the prior art, the present invention offers advantages in that it incorporates a linked automatic covering structure between the seat body and the connector. This structure comprises a flexible decorative panel with its upper end secured to the seat back and its lower end secured to the connector, and a fixing assembly that, when the connector and seat body move relative to each other, causes the flexible decorative panel to deform or displace, through guidance or elastic action, to automatically cover the adjustment holes.

Because the upper end of the flexible decorative panel is fixed to the seat back and the lower end is connected to the connector, the fixing assembly uses guidance or elasticity to cause the flexible decorative panel to deform or displace accordingly when the two move relative to each other.

This seamlessly connects the seat adjustment movement with the decorative panel movement. This linkage also enables automatic covering of the back adjustment holes. This solves the aesthetic issue of exposed back adjustment holes in existing seat designs, prevents dust and debris from accumulating in the holes, and reduces cleaning complexity. It also simplifies the decorative panel's operation, improving user experience and product quality.

### BRIEF DESCRIPTION OF THE DRAWINGS

FIG. 1 is a schematic diagram of the three-dimensional structure of Example 1;

FIG. 2 is a schematic diagram of the coordinated structure of the connector, the linked automatic covering structure, and the seat back in Example 1;

FIG. 3 is a schematic diagram of the reverse side of FIG. 2;

FIG. 4 is a schematic diagram of the exploded structure of FIG. 2;

FIG. 5 is a schematic diagram of the structure of the linked automatic covering structure covering the adjustment hole in Example 2;

FIG. 6 is a schematic diagram of the structure of the linked automatic covering structure opening the adjustment hole in Example 2;

FIG. 7 is a schematic diagram of the structure of the linked automatic covering structure covering the adjustment hole in Example 3;

FIG. 8 is a schematic diagram of the structure of the linked automatic covering structure opening the adjustment hole in Example 3.

### DETAILED DESCRIPTION

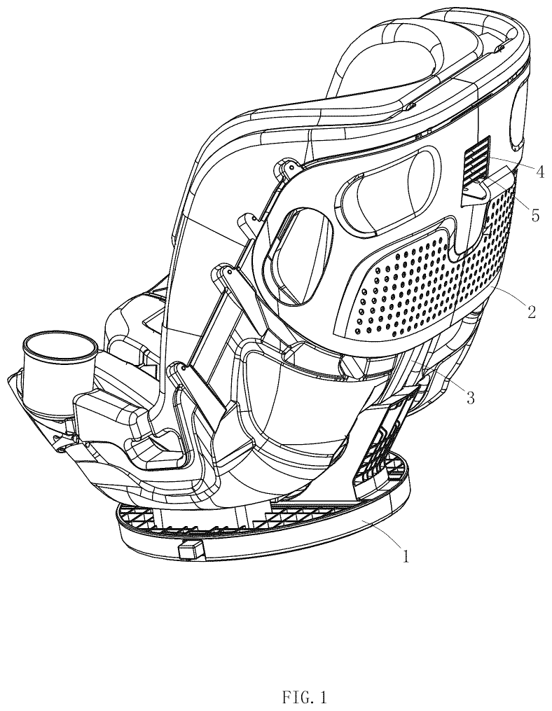

The present invention will be described in further detail below with reference to the accompanying drawings and embodiments. FIGS. 1 to 8 show schematic diagrams of three embodiments of the present invention. The child safety seats in Examples 1 to 3 each include a chassis 1, a seat body 2, a connector 3, an adjustment hole 4, a flexible decorative panel 5, a fixing assembly 6, and other components. The following describes three different embodiments in detail with reference to the accompanying drawings.

### Example 1

This Example 1 corresponds to FIGS. 1 to 4 and is suitable for child safety seat applications that require convenient operation and good aesthetics. The structure and connection relationships of its components are as follows:

Referring to FIG. 1, the chassis 1 serves as the basic support structure, providing a stable mounting platform for the seat body 2. The seat body 2 can be adjusted relative to the chassis 1 to meet different usage requirements. The connector 3 is mounted on the chassis 1 and moves relative to the seat body 2 during adjustment. An adjustment hole 4 is provided on the back of the seat body 2 to avoid the protruding portion of the connector 3, ensuring smooth adjustment.

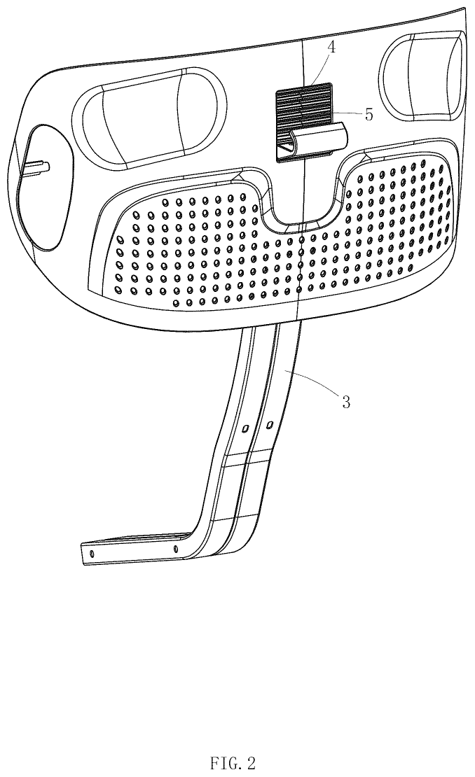

Referring to FIGS. 2 to 4, in Example 1, the flexible decorative panel 5 is a foldable retractable curtain, and the fixing assembly 6 includes a first mounting portion 6a and a second mounting portion 6b. The fastener 6a1 of the first mounting portion 6a secures the top of the retractable curtain to the back of the seat body 2, ensuring a secure connection. The buckle 6b1 of the second mounting portion 6b is located at the bottom of the retractable curtain. The connector 3 has a matching latch hole 31, which consists of a large hole 31a and a small hole 312. During installation, the buckle 6b1 is inserted through the large hole 31a and then moved laterally to the small hole 312. The elastic deformation of the neck of the buckle 6b1 locks it into the small hole 312, thus achieving a removable connection between the bottom of the retractable curtain and the connector 3.

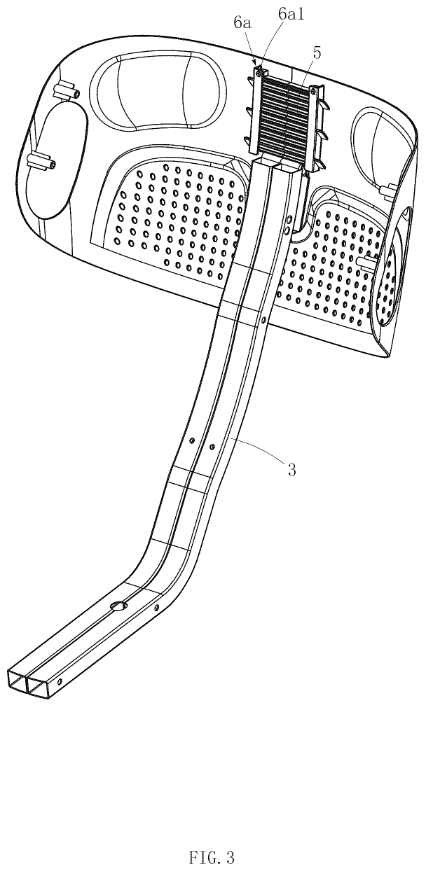

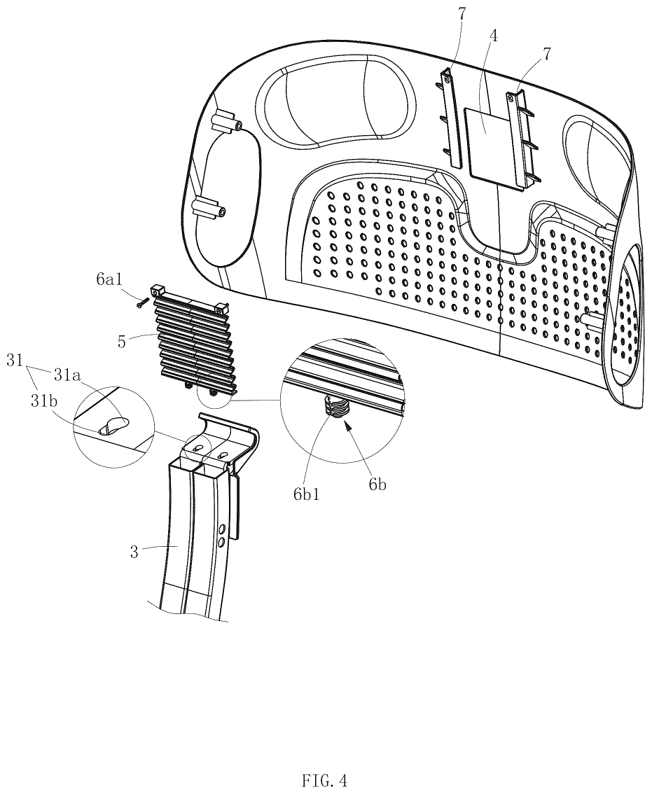

To ensure the stability of the retractable curtain during movement, as shown in FIGS. 3 and 4, a guide groove 7 is provided on the back of the seat body 2. The edge of the retractable curtain engages with the guide groove 7, restricting its movement to a predetermined path.

The assembly process of the components in Example 1 is as follows: First, the connector 3 is mounted on the chassis 1, ensuring a secure and accurate fit. Next, the guide groove 7 is installed on the back of the seat body 2, ensuring its precise installation. Finally, the top of the retractable curtain is secured to the back of the seat body 2 using fasteners 6a1. Next, align the buckle 6b1 at the bottom of the retractable curtain with the latch hole 31 on the connector 3 and complete the installation according to the steps.

Finally, install the seat body 2 onto the chassis 1, ensuring a tight connection and normal relative movement. The operating principle of the linked automatic covering structure in Example 1 is as follows: When the seat body 2 needs to be adjusted, such as for pitch adjustment, the seat body 2 moves relative to the chassis 1, driving the connector 3 to move relative to it. If the seat body 2 is adjusted upward, the connector 3 moves downward relative to it, and the retractable curtain gradually unfolds under the pull of the connector 3.

Due to the restraining effect of the guide groove 7, the retractable curtain smoothly unfolds along the predetermined path, automatically covering the adjustment hole 4. When the seat body 2 is adjusted downward, the connector 3 moves upward relative to it, and the retractable curtain gradually folds, but always covers the adjustment hole 4, effectively preventing the adjustment hole 4 from being exposed, improving the seat's aesthetics and ease of cleaning.

### Example 2

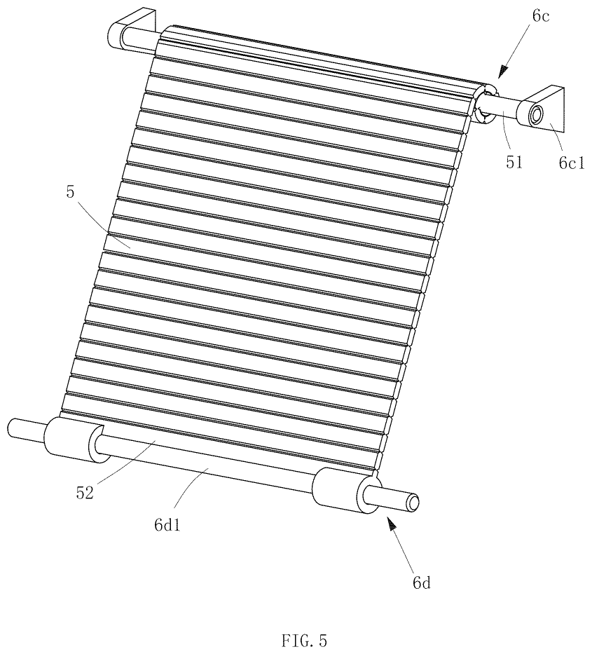

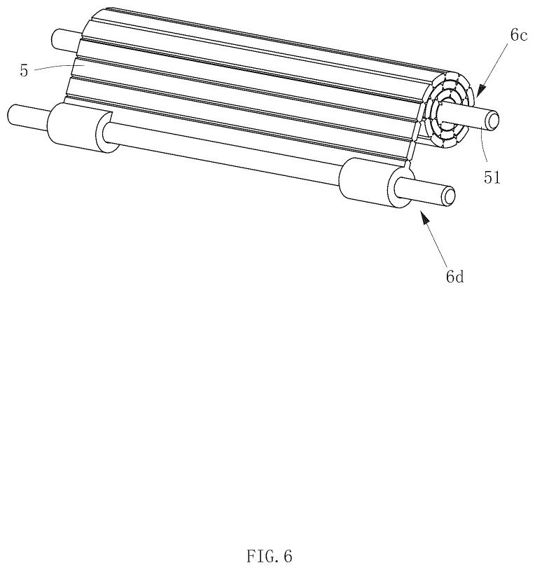

Example 2 corresponds to FIGS. 5 and 6 and is suitable for applications where a neat seat appearance and the stability of the automatic covering structure are highly important.

In Example 2, the flexible decorative panel 5 is a roller blind. The fixing assembly 6 includes a reel mounting portion 6c and a free-end fixing portion 6d. The reel mounting portion 6c includes a reel bracket 6c1 located on the back of the seat body 2. The bracket 6c1 is used to secure the roller blind's reel 51. The reel 51 of the roller blind incorporates a torsion spring, one end of which is secured to the reel bracket 6c1 and the other end to the reel 51.

Since the torsion spring is a conventional structure for roller blinds, it is not shown in detail in the accompanying drawings. The free-end fixing portion 6d utilizes a clamping structure 6d1 located on the connecting member 3, primarily securing the free end 52 of the roller blind.

To ensure greater stability during movement, the back of the seat body 2 can also be provided with guide grooves or rails to guide the edge of the roller blind. During assembly, first install the reel bracket 6c1 on the back of the seat body 2, then attach the reel 51 with the built-in torsion spring 53 to the reel bracket 6c1.

Then, secure the free end 52 of the roller blind to the connector 3 using the clamping structure 6d1. Finally, install the seat body 2 onto the chassis 1, ensuring that the guide groove or slide rail fits the roller blind properly.

The operating principle of the linked automatic covering mechanism in Example 2 is as follows: When pitch adjustment is required, the seat body 2 moves, causing relative movement with the connector 3. If the seat body 2 is adjusted upward, the connector 3 moves downward relative to it, stretching the free end 52 of the roller blind, rotating the reel 51, and storing elastic energy in the torsion spring. If the seat body 2 is adjusted downward and the connector 3 moves upward relative to it, the torsion spring releases this elastic energy, driving the reel 51 to automatically wind the roller blind, ensuring that the roller blind always covers the adjustment hole 4.

Throughout this process, the guide groove or slide rail ensures stable movement of the roller blind, while the power provided by the torsion spring ensures smooth winding and unwinding of the roller blind, effectively improving the effectiveness and reliability of the automatic covering.

### Example 3

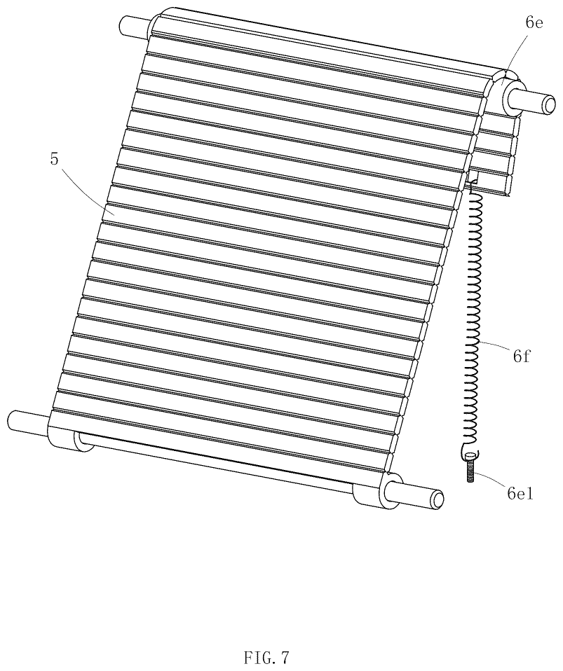

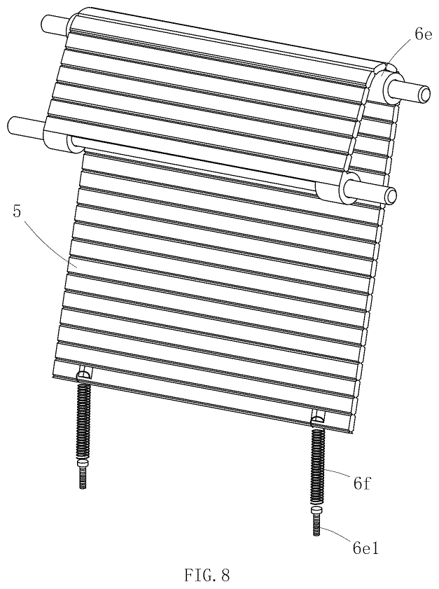

Example 3 corresponds to FIGS. 7 and 8 and is suitable for scenarios requiring special flexibility and adjustability of the automatic seat cover structure, such as frequent adjustments to the seat angle. In Example 3, the flexible decorative panel 5 is a curtain, and the fixing assembly 6 includes a tension spring 6e and a transition shaft 6f. One end of the curtain is secured to the back of the seat body 2 via the tension spring 6e.

The end of the tension spring 6e is also secured via an adjustable bolt 6e1, allowing for easy adjustment of the preload of the tension spring 6e. The transition shaft 6f is located on the back of the seat body 2 and slidably connected to the center of the curtain. The transition shaft 6f can rotate about its axis to distribute tensile stress and reduce frictional resistance.

The other end of the curtain is secured to the connector 3. Similarly, the back of the seat body 2 is also provided with guide grooves or rails to constrain the curtain's movement. During assembly, first install the transition shaft 6f on the back of the seat body 2, ensuring it can rotate freely.

Next, use the adjustable bolt 6e1 to fix one end of the tension spring 6e to the back of the seat body 2, and then connect one end of the curtain to the tension spring 6e, and the middle of the curtain is slidably connected to the transition shaft 6f.

Then, fix the other end of the curtain to the connecting piece 3. Afterwards, install the seat body 2 and chassis 1, and check the fit between the guide groove or slide rail and the curtain. The operating principle of the central linkage automatic covering structure in Example 3 is as follows: When pitch angle adjustment is required, the seat body 2 moves, causing relative movement with the connector 3.

As the connector 3 moves downward, the curtain is pulled, and with the assistance of the transition shaft 6f, it smoothly covers the adjustment hole 4. When the connector 3 moves upward, the tension spring 6e retracts the curtain. By adjusting the adjustable bolt 6e1, the preload of the tension spring 6e can be varied to meet the covering requirements of different adjustment levels. For example, for larger angle adjustments, the preload of the tension spring 6e can be increased to ensure that the curtain completely covers the adjustment hole 4; for smaller angle adjustments, the preload can be appropriately reduced to ensure more flexible curtain movement. The guide groove or slide rail ensures the curtain's stability during movement, and the rotation of the transition shaft 6f effectively reduces wear on the curtain, thereby increasing the service life and adaptability of the entire structure.

It should be noted that in the description of this embodiment, the terms “front, rear,” “left, right,” “up, down,” and so forth, indicating directions or positions, are based on the directions or positions shown in the accompanying drawings. These terms are intended solely to facilitate the description of the present invention and simplify the description. They are not intended to indicate or imply that the devices or components referred to must have a specific orientation, be constructed, or operate in a specific manner.

Therefore, they should not be construed as limitations on the present invention. The terms “mounted,” “connected,” and “connected” should be interpreted broadly, meaning, for example, fixed, removable, or integral; directly, indirectly through an intermediary, or internally connected between two components. Those skilled in the art will understand the specific meanings of these terms in this invention based on the specific circumstances.

1. A child safety seat, comprising:
a chassis (1) and
a seat body (2) movable relative to the chassis (1) during adjustment, wherein the chassis (1) is provided with a connecting member (3) which moves relative to the seat body (2) during adjustment, and an adjustment hole (4) is provided on the back of the seat body (2) for avoiding the protruding portion of the connecting member (3), characterized in that: a linkage automatic covering structure is provided between the seat body (2) and the connecting member (3), and the linkage automatic covering structure comprises a flexible decorative plate (5) and a fixing assembly (6);
the upper end of the flexible decorative plate (5) is fixed to the back of the seat body (2), and the lower end is fixed to the connecting member (3); The fixing assembly (6) is configured to cause the flexible decorative plate (5) to deform or displace by guiding or elastic action when the connecting member (3) and the seat body (2) move relative to each other, so as to automatically cover the adjustment hole (4).

2. The child safety seat according to claim 1, characterized in that: the flexible decorative panel (5) is a foldable telescopic curtain, the fixing assembly (6) includes a first mounting portion (6a) and a second mounting portion (6b), the upper end of the telescopic curtain is fixed to the back of the seat body (2) through the first mounting portion (6a), and the lower end is fixed to the connecting member (3) through the second mounting portion (6b), and the telescopic curtain automatically covers the adjustment hole (4) by folding or unfolding during relative movement.

3. The child safety seat according to claim 2, characterized in that: the first mounting portion (6a) includes a fastener (6a1), and the top of the retractable curtain is fixedly connected to the back of the seat body (2) via the fastener (6a1); The second mounting portion (6b) includes a buckle (6b1) provided at the bottom of the retractable curtain, and the connecting member (3) is provided with a locking hole (31) adapted to the buckle (6b1), and the buckle (6b1) and the locking hole (31) are engaged through the buckle hole to achieve a detachable connection of the bottom of the retractable curtain.

4. The child safety seat according to claim 3, characterized in that: the latch hole (31) comprises a large hole (31a) and a small hole (312) that are interconnected, the large hole (31a) being larger than the head of the buckle (6b1), and the small hole (312) being adapted to the neck of the buckle (6b1), and the buckle (6b1) being inserted through the large hole (31a) and then moved laterally to the small hole (312), and being locked in the small hole (312) by elastic deformation of the neck of the buckle (6b1).

5. The child safety seat according to claim 1, characterized in that: the flexible decorative panel (5) is a roller blind, and the fixing assembly (6) includes a roller shaft mounting portion (6c) and a free end fixing portion (6d); the roller shaft mounting portion (6c) includes a roller shaft bracket (6c1) provided on the back of the seat body (2) for fixing the roller shaft (51) of the roller blind; the free end fixing portion (6d) includes a clamping structure (6d1) or a magnetic adsorption member provided on the connecting member (3) for fixing the free end (52) of the roller blind; the rolling or unrolling of the roller blind is achieved by the relative movement of the seat body (2) and the connecting member (3).

6. The child safety seat according to claim 5, characterized in that: the roller shaft (51) of the roller blind is internally provided with a torsion spring, one end of the torsion spring being fixed to the roller shaft bracket (6c1) and the other end being fixed to the roller shaft (51); When the connecting member (3) and the seat body (2) are in relative motion, the free end (52) of the roller blind is stretched or released, and the torsion spring drives the roller shaft (51) to automatically wind or unwind the roller blind through elastic potential energy.

7. The child safety seat according to claim 1, characterized in that: the flexible decorative panel (5) is a curtain, and the fixing assembly (6) includes a tension spring (6e) and a transition shaft (6f); one end of the curtain is fixed to the back of the seat body (2) via the tension spring (6e), and the other end is fixed to the connecting member (3); the transition shaft (6f) is provided on the back of the seat body (2) and is slidably connected to the middle portion of the curtain; when the connecting member (3) is in a downward position, the curtain is pulled to cover the adjustment hole (4); when the connecting member (3) is in an upward position, the tension spring (6e) drives the curtain to retract.

8. The child safety seat according to claim 7, characterized in that: the transition shaft (6f) can rotate about its own axis to disperse the tensile stress of the curtain and reduce frictional resistance; The end of the tension spring (6e) is fixed to the back of the seat body (2) via an adjustable bolt (6e1), and the adjustable bolt (6e1) is used to adjust the preload force of the tension spring (6e) to adapt to the covering requirements of different adjustment gears.

9. The child safety seat according to claim 1, characterized in that: the guiding function of the fixing assembly (6) is achieved through a guide groove (7) or a slide rail, and the guide groove (7) or slide rail is provided on the back of the seat body (2) to constrain the movement path of the flexible decorative panel (5).

10. The child safety seat according to claim 9 is characterized in that the relative movement of the connecting member (3) and the seat body (2) is pitch angle adjustment, and the covering range of the flexible decorative panel (5) corresponds to the adjustment hole (4) exposed after the pitch angle adjustment gear is adjusted, so as to dynamically cover the adjustment hole (4) exposed after adjustment.
